(19) United States
(12) Patent Application Publication
(10) Pub. No.: US 2004/0011923 A1
(43) Pub. Date: Jan. 22, 2004

(54) Efficient wings

(76) Inventor: John Daniel Romo, Manhattan, NY (US)

Correspondence Address: JOHN DANIEL ROMO, 825 W. 179th ST. 4F, MANHATTAN, NY, 10033, US

(21) Appl. No.: 10/156,205

(22) Filed: Jul. 22, 2002

(51) Int. Cl. B64C 15/02; B64C 29/00

(52) U.S. Cl. 244/12.3

(57) ABSTRACT

To obtain an augmented lift coefficient for a given airfoil set at a maximum angle of attack (α), in a steady state airflow system, a shrouded motorized propeller is installed normal to its upper side, creating additional airflow. An outlet for the additional airflow is provided including a horizontal motorized propeller placed at the trailing edge of the airfoil. The motorized propeller converts the additional air flow into a down-wash generating additional lift. Neither the first nor the second installation alone will produce the augmented lift efficiently. Therefore, the combination of the first and the second installation is needed. The propeller-wing arrangement is implement in the airfoils.

### BACKGROUND OF THE INVENTION

1. Field of the Invention

The present invention relates to airfoils and more particularly to a device for augmenting the lift of an airfoil in transition between vertical and horizontal flight.

2. Discussion of the Prior Art

U.S. Pat. No. 4,447,028: Wang, Timothy. Upper surface blown powered lift system for aircraft. Issued May 8, 1984.

U.S. Pat. No. 4,283,029: Rudolph, Peter K. Actuating apparatus for a flap system having an upper blowing powered lift system. Issued Aug. 11, 1981.

U.S. Pat. No. RE 029,023: Malvestuto Jr., Frank S. Method of propeller augmented lift for airplanes. Issued Nov. 2, 1976.

U.S. Pat. No. 5,454,530: McDonnell Douglas Helicopter Co. Canard propeller/wing. Issued October 1995.

U.S. Pat. No. 4,874,291: Roberts et al. Propeller arrangement for a propeller craft. Issued Oct. 17, 1989/May 20, 1988 E2 (expired).

U.S. Pat. No. 4,730,795: David. Heliplane. Issued March 1988.

U.S. Pat. No. 4,469,294: Clifton. V/STOL aircraft. Issued September 1984.

U.S. Pat. No. 3,037,721: Stefanutti, Sergio. The compound helicopter with shrouded propeller.

U.S. Pat. No. 3,241791: Piasecki, F. K. “Fluid Motor Driven Multi Propeller Aircraft” is a propeller-tilt version of the four propeller configuration. The wings shown have no relation to the propellers mounted on the top of the aircraft.

U.S. Pat. No. 3,873,049: Hordal. Flying machine. Issued March 25, 1975.

U.S. Pat. Nos. 6,082,478 and 5,803,199: Walter, William C. Issued July 4, 2000 and Sep. 8, 1998 respectively. These patents describe a lift augmented ground effect platform based on hovercraft technology.

Other systems have been described, including an exo-skeletor flying machine, a sky-car having propellers installed in nacelles, and thrust deflectors. However, no known apparatus describes an apparatus and method for generating augmented lift including shrouded propellers mounted above an airfoil and at the airfoils trailing edge. Therefore, a need exists for an apparatus for generating augmented lift.

### SUMMARY OF THE INVENTION

According to an embodiment of the present invention, an efficient wing is provided. The wing includes a shrouded motorized propeller installed substantially vertical to the upper side of the wing creating additional airflow over the top of the wing and increasing the lift provided by the wing accordingly. An outlet for the airflow over the top of the wing is provided by a shrouded motorized propeller mounted on the trailing edge of the wing. The propeller mounted on the trailing edge converts the airflow over the top of the wing into a down wash, generating additional lift. Neither the first nor the second installation alone will produce the desired augmented lift efficiently. Therefore, the combination of the vertical and horizontal propellers is needed to create the desired augmented lift.

According to an embodiment of the present invention, a gliding aircraft is provided. The aircraft includes four propellers mounted on two efficient wings. A first pair of propellers are mounted substantially horizontal and extend from the trailing edges of the efficient wings. A second pair of propellers are mounted substantially vertical and extend from the tops of the efficient wings. A pair of counter-rotating propellers mounted in a shroud on the rear of the aircraft.

The shrouded propellers mounted on the tops of the efficient wings provide forward and reverse thrust. The two propellers mounted on the trailing edges of the efficient wings and the counter-rotating propellers on the rear of the aircraft provide a portion of the lift.

### BRIEF DESCRIPTION OF THE DRAWINGS

Preferred embodiments of the present invention will be described below in more detail, with reference to the accompanying drawings:

FIG. 1 shows a airfoil;

FIG. 2 shows an airfoil having a shroud enclosing a propeller according to an embodiment of the present invention;

FIG. 3 shows an airfoil having multiple propellers according to an embodiment of the present invention;

FIG. 4 shows a configuration of shrouds on an airfoil according to an embodiment of the present invention;

FIG. 5a depicts an aircraft including efficient wings according to an embodiment of the present invention;

FIG. 5b depicts an aircraft including efficient wings according to an embodiment of the present invention;

FIG. 6 depicts a side view of the aircraft shown in FIG. 5a according to an embodiment of the present invention; and

FIG. 7 depicts a front view of the aircraft shown in FIG. 5a according to an embodiment of the present invention.

### DETAILED DESCRIPTION OF PREFERRED EMBODIMENTS

Propeller wing aircraft which are designed to convert from vertical flight to horizontal flight need to augment lift in the transition. According to an embodiment of the present invention, a device is provided for augmenting the lift of an airfoil.

Augmented lift for airfoils subjected to external flow where the corresponding Mach number is <0.3. The present invention utilizes fluid mechanics, specifically, the pressure decreases as the velocity in a fluid increases. This relationship is described as the Bernoulli Equation, where the variables, including pressure, velocity, and density appear on both sides on the relationship. The relationship may be expressed as:

p₁+pgy₁+½pv₁²=p₂+pgy₂+½pv₂² 1

The subscripts 1 and 2 refer to any two points along a given flow tube. Therefore:

p+pgy+½pv²=constant 2

Further, an abstraction of potential energy may be written as:

p+½pv²=constant 3

Equation [3] governs the calculations that determine the magnitude of the vectors representing lift for a given airfoil subjected to a system of external fluid flow in this invention.

In a system of steady external flow a given airfoil is introduced. Then a difference in pressure is manifested within the system. The pressure in the airfoil's upperside becomes lower since the velocity of its flow is greater. Then the higher pressure in its underside results in lift. Lift generated in this system is due only to the airfoil aerodynamics shape. Since additional lift for the airfoil is desired, under the conditions described, this invention utilizes a combination of sources external to the system in question to obtain it.

To obtain an augmented lift coefficient for a given airfoil set at a maximum angle of attack (α), in a steady state airflow system, a shrouded motorized propeller is installed normal to its upper side, creating additional airflow. An outlet for the additional airflow is provided including a horizontal motorized propeller placed at the trailing edge of the airfoil. The motorized propeller converts the additional air flow into a down-wash generating additional lift. Neither the first nor the second installation alone will produce the augmented life efficiently. Therefore, the combination of the first and the second installation is needed. The propeller-wing arrangement is implement in the airfoils.

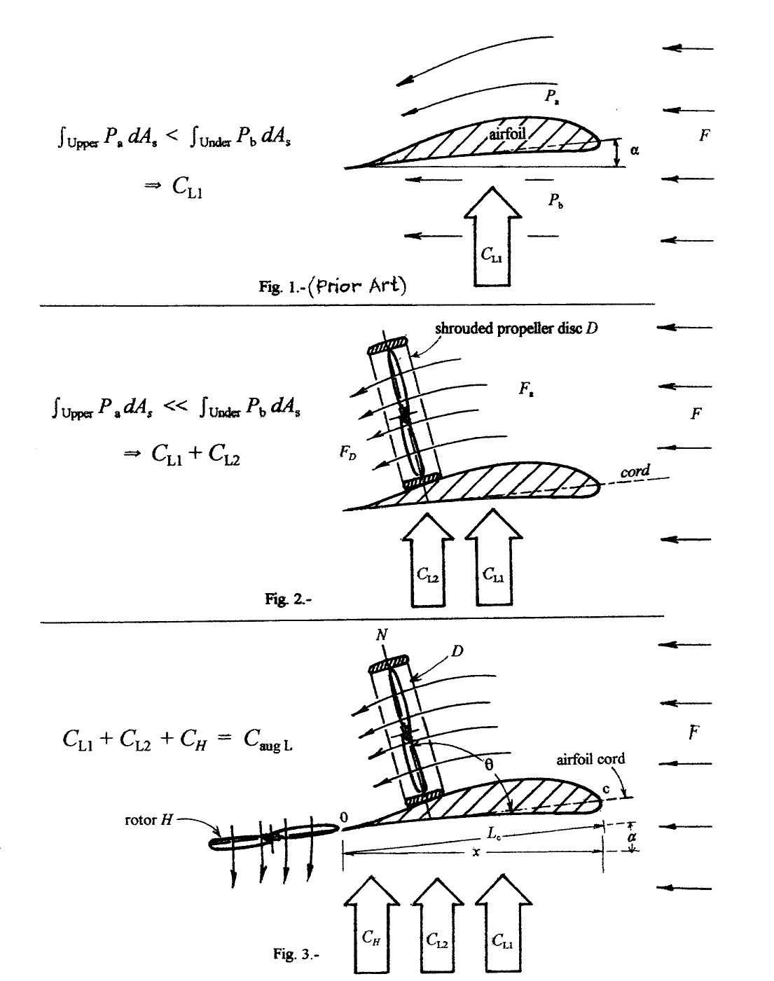

The airfoil can be those of an ordinary airplane as well as those of other aircraft, such as airfoils of hybrid aircraft such as the V-22 Osprey. FIG. 1 depicts an airfoil introduced into a steady state airflow F that is dividing the airflow into an upper side a, and underside b. The upward arrow C_{L1}, represents the resulting lift coefficient, caused by the difference between the indefinite integration of pressure Pₐ and pressure P_{b}. This may be written as the following inequality:

∫_{Upper}PₐdAₛ<∫_{Under}P_{b}dAₛ 4

Where Aₛ is the surface area of the airfoil.

Referring to FIG. 2, the airflow stream Fₐ is accelerated by means of the shrouded propeller disc D. Where the resulting airflow stream F_{D} is reducing the pressure further than what the aerodynamic shape of the airfoil had achieved. Thus, the lift coefficient increases further. This additional lift coefficient C_{L2} can then be claimed upon the much larger difference between the two pressures, which may be expressed by the much larger inequality of:

∫_{Upper}PₐdAₛ<<∫_{Under}P_{b}dAₛ 5

where <<, the much larger difference, corresponds to the addition of the lift coefficient C_{L2} and the previously obtained C_{L1}.

Referring to FIG. 3, a motorized horizontal propeller H, is installed at the airfoil's trailing edge, where the additional airflow coming from the airfoil's upper side converts into down-wash. The horizontal propeller H, which completes the cycle of pressured airflow started by D, a less efficient and incomplete airflow cycle will take place. Adding C_{H} to the previously found addition of C_{L1} and C_{L2} gives the desired augmented lift coefficient C_{augL} as follows:

C_{L1}+C₂+C_{H}=C_{augL} 6

where C_{H} is equal to a lift coefficient produced by H, depicted in FIGS. 3a and 3b.

The augmented lift coefficient can be written as:

$${C}_{L} = \frac{1}{{L}_{c}} {\int }_{0}^{c} [ {( {C}_{p} )}_{-} - {( {C}_{p} )}_{+} ] ⅆ x \qquad 7$$

where:

L_{c} is the length of the airfoil cord (from 0 to c);

(Cₚ)₋ is the pressure coefficient on the underside of the airfoil; and

(Cₚ)₊ is the pressure coefficient on the upperside of the airfoil.

Both the underside and the upperside pressure coefficients can be written as:

$$\begin{matrix}{C}_{P} = ( P - {P}_{∞} ) / ( \frac{1}{2} ρ ∞ {V}_{∞}^{2} ) & 8 \\ = ( 2 / γ {M}_{∞}^{2} ) [ ( P / {P}_{∞} ) - 1 ] & 9\end{matrix}$$

Where:

γ=pressure/volume ratio (Cₚ/Cᵥ)=1.4

M=Mach number<0.3

Shown in FIG. 3, the position of optimum efficiency for D, which is given by the angle theta (θ) which is formed by N, the normal to the curve of the airfoil, the normal is also the center line of the shrouded propeller disc (D), and the airfoil's cord. Also shown is L_{C}, the length of the airfoil cord, which is the interval of the integration from zero to c, as described in equation [7]. The length x=cosα.

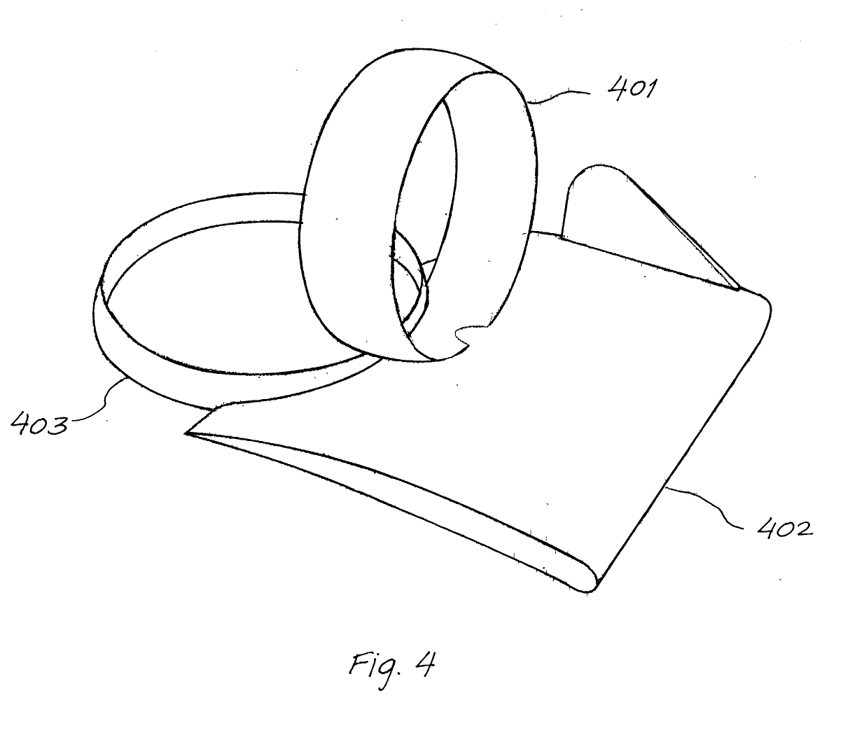

FIG. 4 is a view of a substantially vertical shroud 401, including a shrouded propeller, normal to an airfoil 402. The airfoil 402 includes a substantially horizontal shroud 403, including a propeller, installed at the trailing edge of the airfoil 402. The horizontal propeller coverts the airflow over the top of the airfoil 402, and augmented by the vertical propeller, into augmented lift in the form of down wash.

According to an embodiment of the present invention, a gliding helicopter is provided. The aircraft is designed to take off from limited spaces and maneuver on the ground. The aircraft may be used as, for example, a police patrol vehicle, emergency medial aid or rescue vehicle, and corporate transportation. The aircraft includes multiple propellers, and is capable of transferring between vertical flight (including hovering) and horizontal flight. The aircraft incorporates the efficient wings described above.

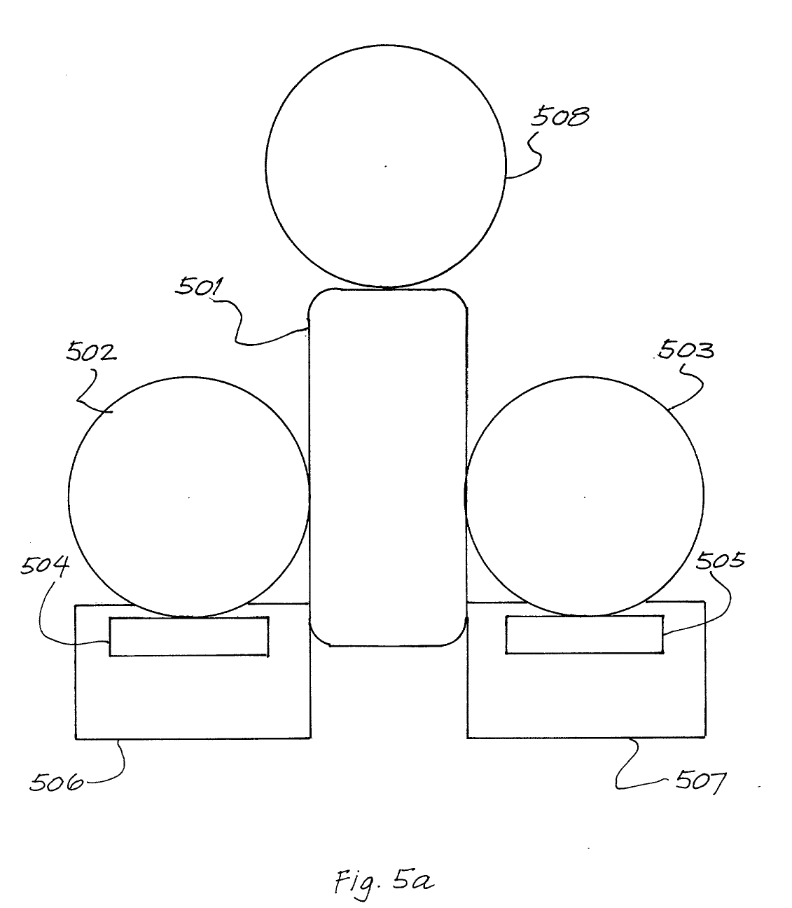

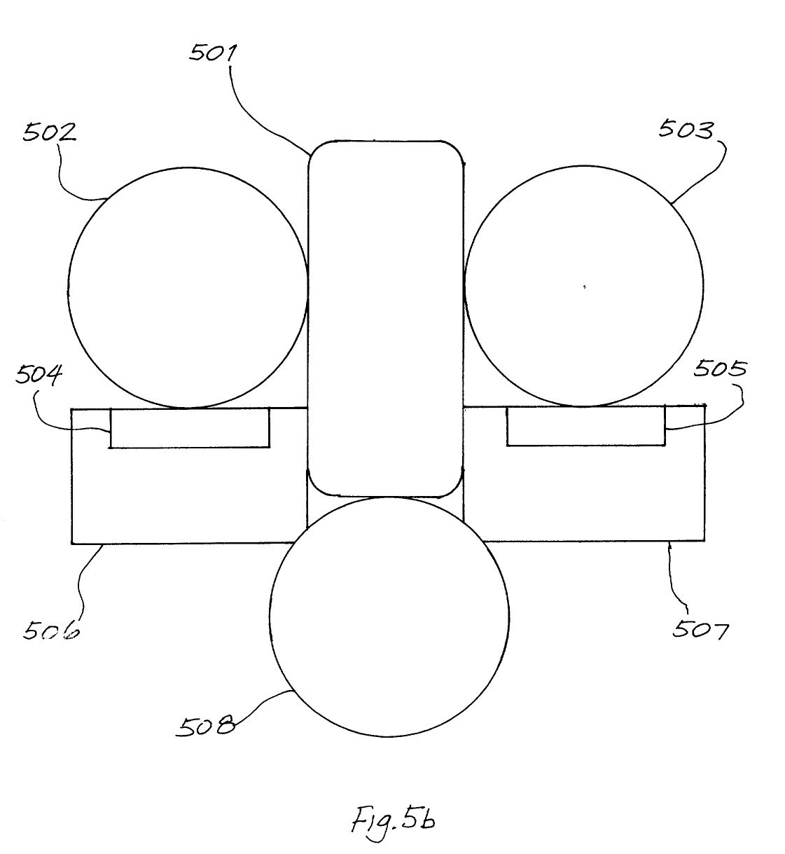

The aircraft includes at least four shrouded propellers connected to two efficient wings. The efficient wings are connected to a centrally located fuselage. Referring to FIGS. 5a and 5b, a view of the aircraft is shown from above. The fuselage 501 includes four shrouded propellers 502-505 connected to the efficient wings 506-507. The shrouded propellers connect to the efficient wings are counter-rotating, for example, propeller 502 and propeller 503 rotate in opposite directions. A fifth shrouded propeller 508 is connected to the rear of the aircraft and positioned horizontally. The fifth shrouded propeller 508 includes two counter-rotating propellers within the shroud. Thus, shroud 508 may be taller than shrouds 502 and 503 to accommodate the additional propeller.

During the aircraft's take-off, the propellers 502-503 and 508 lift the aircraft. When a desired altitude is achieved, the propellers 504-505 can provided thrust for forward or reverse movement. In forward flight the efficient wings generate a portion of the lift sufficient to maintain flight, added by shrouded propellers 502-503 and 508. Shrouded propellers 502, 503 and 508 form a substantially equilateral triangle which, inter alia, provides stability and flight characteristics similar to that of a conventional helicopter.

The transition from vertical to horizontal flight may be described by a curve, similar to the curve of a traditional helicopter at take-off. The transfer from vertical to horizontal flight occurs as the blade pitch of the four horizontal propellers, 502-503 and 508, decreases, while the blade pitch of propellers 504-505 simultaneously increases.

The shrouded propellers 508 may be positioned at the rear and/or front of the fuselage 501. Both configurations are contemplated by the present invention. Positioning the shrouded propellers 508 at the rear of the fuselage 501, as shown in FIG. 5a, increases visibility versus the front mounted configuration for driving/flying the vehicle shown in FIG. 5b. Referring to FIG. 5b, mounting the shrouded propellers 508 at the front of the fuselage 501 may be use when visibility is less of a concern. Shrouded propellers 508 provide augmented lift in both configurations. For increased augmented lift, shrouded propellers 508 may be installed at the rear and the front of the fuselage simultaneously.

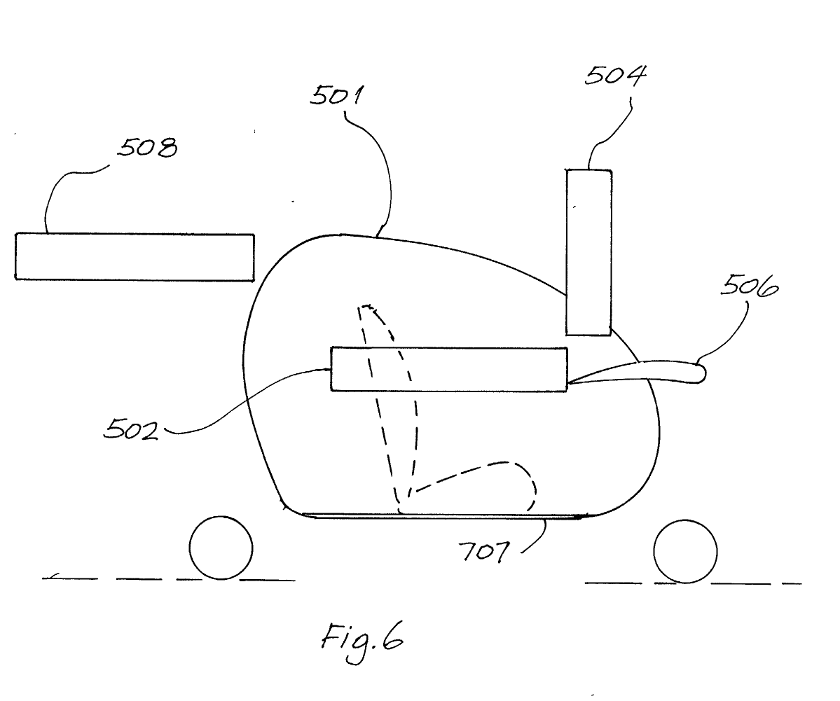

Referring to FIG. 6 showing a cross-section of the aircraft, the horizontal shroud 502 and the vertical shroud 504 form an angle. The airfoil 506 is partly imbedded in horizontal shroud 502. Shroud 504 is mounted on the upper side of the airfoil 506, and can be partially embedded therein. Also depicted is shroud 508, including the two counter-rotating propellers, mounted on the rear of the fuselage 501.

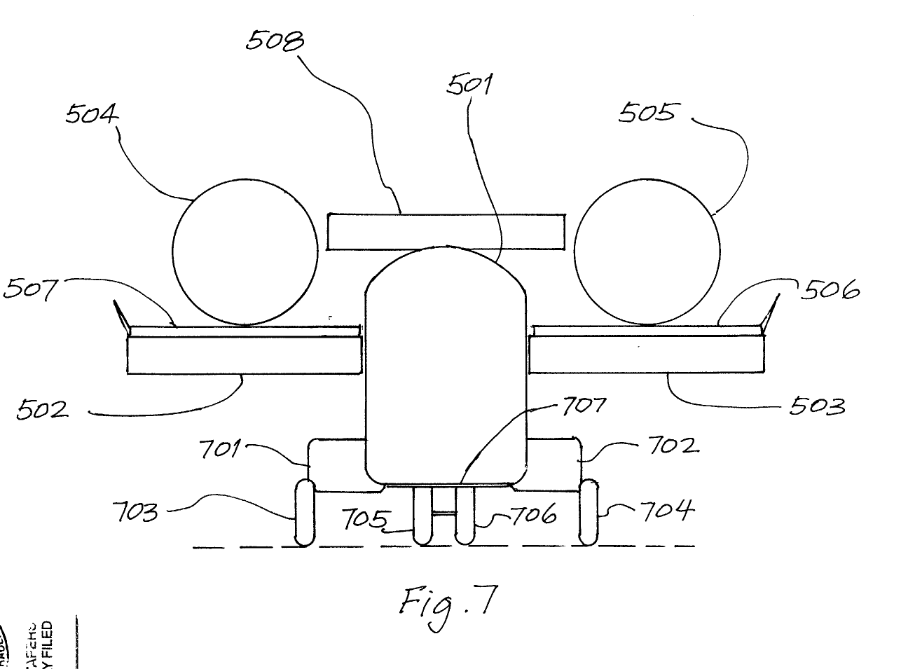

Referring to FIG. 7, a view of the front of the aircraft, two engines 701-702 are mounted to the sides of the fuselage 501. The aircraft also includes four wheels 703-706 connected to the chassis 707. The rear wheels 703-704 may be motorized to provide locomotion while on the ground. The front wheels 705-706 can provide directional control.

According to an embodiment of the present invention, an aircraft wing using the combination of shrouds described herein can generate the lift of a larger wing without the combination. The gliding helicopter having the combination of shrouds will not generate the rotational inertial momentum typically generated by traditional helicopters. The combination of shrouded propellers will give a pilot greater control over the take off and landing maneuvers as compared to a convtiplane such as the V-22 Osprey.

Having described embodiments of a system and method for augmenting lift, it is noted that modifications and variations can be made by persons skilled in the art in light of the above teachings. It is therefore to be understood that changes maybe made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

I claim that my inventions are:

1. -Efficient Wings, consisting of a rotor(s) mounted substantially normal to a horizontal rotor that is attached to the trailing edge of an airfoil such that the arrangement generates augmented lift for said airfoil.

2. -Inertial momentum free Transfer Path, consisting of “Efficient Wings” (1) being used to perform an aircraft transfer from vertical to horizontal flight or vice-versa by simultaneously changing the blade pitch of the efficient wings rotors as one rotor open its angle of attack (α), and the other one is being closed. Meanwhile the rpm of the said rotors is kept constant.

3. -Differential equations that represents claim (2) when implemented in take-off and landing maneuvers of rotor-tilt aircraft that are written as follows:
dα_{y}/dt=ƒ(−dαₓ/dt)
and
(−dα_{y}/dt=ƒ(dαₓ/dt)
Where α, the angle of attack varies on one rotor from α=0 to α>0, and on the other rotor α varies from α>0 to α=0.

4. -Applications of “Inertial momentum free Transfer Path” in rotor-tilt aircraft such as V-22 Osprey.

5. -Combinations, in all forms of claims 1, 2, and 3 into aircraft of all types.

6. -Modified Quadrille Layout, consisting of four counter-rotating rotors arranged into three rotors by having one rotor counter-rotating itself.
